(19) United States
(12) Patent Application Publication
(10) Pub. No.: US 2006/0220333 A1
(43) Pub. Date: Oct. 5, 2006

(54) Universal wheeled assembly for gas and electric line trimmers

(76) Inventor: Shirley Ann Olson, New London, MN (US)

Correspondence Address: Shirley Ann Olson, 16323 54th Street NE, New London, MN, 56273, US

(21) Appl. No.: 11/067,550

(22) Filed: Feb. 25, 2005

(51) Int. Cl. B62B 3/00

(52) U.S. Cl. 280/47.34; 280/29; 56/15.6

(57) ABSTRACT

A universal wheeled assembly to support hand-held devices such as trimmers, metal detectors and the like. The wheeled frame assembly includes two anti-vibration clamps arranged to allow the head of a trimming device and the like to pivot from side to side horizontally and provide secured attachment to said devices. The wheeled frame assembly includes a cushioned handled for added vibration reduction and comfort for users of devices such as trimming devices, metal detectors and the like. The wheeled frame assembly is able to support the device while permitting the device to operate between a mowing and an edging orientation.

### RELATED APPLICATIONS

The present application is related to U.S. Pat. No. 4,688,376, issued Aug. 25, 1987, for ADJUSTABLE CARRIAGE FOR ELECTRIC STRING TRIMMERS, by Donald E. Wolfe, Sr., included by reference herein.

The present application is related to U.S. Pat. No. 4,704,849, issued Nov. 10, 1987, for WHEEL-MOUNTED WEED TRIMMER, by Zachary R. Gilbert, included by reference herein.

The present application is related to U.S. Pat. No. 4,829,755, issued May 16, 1989, for TRIMMER WHEELS, by Nora S. Nance, included by reference herein.

The present application is related to U.S. Pat. No. 4,891,931, issued Jan. 9, 1990, for WEED CUTTER WHEEL KIT, by Paul Holland, included by reference herein.

The present application is related to U.S. Pat. No. 4,936,886, issued Jun. 26, 1990, for WHEEL MOUNTED STRING TRIMMER, by Ralph D. Quillen, included by reference herein.

The present application is related to U.S. Pat. No. 5,092,112, issued Mar. 3, 1992, for GRASS TRIMMER ATTACHMENT, by Rudy R. Buckendorf, Jr., included by reference herein.

The present application is related to U.S. Pat. No. 5,222,750, issued Jun. 29, 1993, for TOOL-CARRYING APPARATUS AND METHOD, by A. Harlow Ellis, included by reference herein.

The present application is related to U.S. Pat. No. 5,317,807, issued Jun. 7, 1994, for WHEELED SUPPORT STRUCTURE FOR LAWN STRING TRIMMERS, by Bobby L. Pulley, included by reference herein.

The present application is related to U.S. Pat. No. 5,408,816, issued Apr. 25, 1995, for WHEELED, HAND-PROPELLED CARRIAGES FOR HORTICULTURAL DEVICES, by Lucille L. Cartier, included by reference herein.

The present application is related to U.S. Pat. No. 5,450,715, issued Sep. 19, 1995, for WHEEL ASSEMBLY FOR GRASS TRIMMERS AND THE LIKE, by David C. Murray, included by reference herein.

The present application is related to U.S. Pat. No. 5,836,142, issued Nov. 17, 1998, for WHEEL ATTACHMENT CONNECTABLE TO WEED TRIMMERS AND THE LIKE, by Eugene E. Maxwell, included by reference herein.

The present application is related to U.S. Pat. No. 5,970,694, issued Oct. 26, 1999, for QUICK MOUNT LEVELING, ADJUSTABLE AND RETRACTABLE ROLLER STABILIZER FOR STRING TRIMMERS, by Robert J. Knox, Jr., included by reference herein.

### FIELD OF THE INVENTION

A lightweight, wheeled cart assembly which attaches to a line trimmer, metal detector and the like.

### BACKGROUND OF THE INVENTION

This invention attaches to string trimmers, metal detectors and similar such devices to make them less cumbersome to use. The operating unit of the device functions at or near ground level, requiring a user to hold the bulk of the weight at or above waist level, to one side of the body, and manuever the device in order to perform the desired task leading to wrist, arm, back strain and various other stresses. The weight of the device coupled with vibration caused by motorized portions of said devices and the position during use of these devices lead not only to strain or injury but also fatigue.

Another difficulty that currently exists with operating handheld devices is the awkwardness or inability to maneuver into and under objects such as under trees, along fences or buildings.

Although support structures for handheld devices are known in the prior art, their effectiveness in adequately supporting the device and minimizing vibration is questionable, especially where a user must continually grasp the device during operation. One such structure is disclosed in U.S. Pat. No. 4,829,755. This patent involves a wheel assembly attached to a handheld device that includes only one frame member attached near the operating head of the device. Although this structure is adjustable, it does not stabilize the device. Another structure disclosed in U.S. Pat. No. 5,836,142 involves a wheel assembly that includes two frame members attached in two separate positions. This patent stabilizes the device however it does not reduce vibration caused by the device.

A principal object of this invention is provide a stable means of support to carry a gas or electric string trimmer so that it may be operated without strain to back, wrists, arms, neck, etc.

It is another object of the invention to provide a means to reduce vibration caused by a string trimmer by incorporating both anti-vibration clamps and a cushioned handle to reduce injury, strain or fatigue to the wrists, arms, shoulders etc.

Another object of the invention to provide an effective means to use a string trimmer along side buildings and fences by allowing the head of the device to be adjusted side to side horizontally.

Another object of the invention is to provide an easy to operate and assemble attachment that is durable, pleasing to the eye, and allows operator to do an effective job easier, faster and better.

### SUMMARY OF THE INVENTION

In it's basic concept, this invention provides a wheeled assembly that is attached to or removed easily from a string trimmer, metal detector or similiar device without major modification or damage to the device.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a perspective top view of an universal wheeled assembly to support a line trimmer, metal detector or like devices;

FIG. 2 is a top view of an upper shaft of the universal wheeled assembly;

FIG. 3 is a side view of a lower shaft of the universal wheeled assembly showing the vertical support bar assembly and the slide bar assembly;

FIG. 4 is a front view of a vertical support bar;

FIG. 5 is a front view of an axle assembly; and

FIG. 6 is a front view of a slide bar assembly.

For purposes of clarity and brevity, like elements and components will bear the same designations and numbering throughout the FIGURES.

### DESCRIPTION OF THE PREFERRED EMBODIMENT

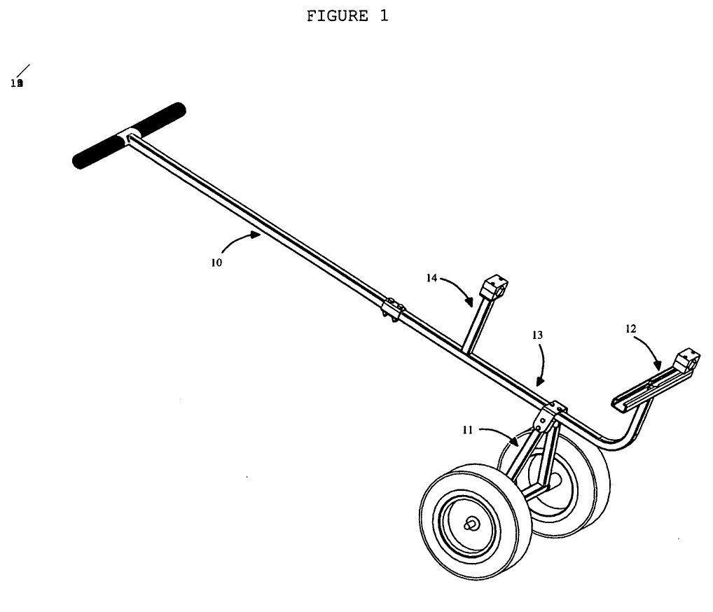

FIG. 1 is the universal wheeled assembly embodying the features for supporting an electric or gas powered line trimmer, metal detector or like devices. The wheeled assembly in this embodiment comprises the upper shaft 10 fastened to the lower shaft assembly 13. The vertical support assembly 14 is fastened to lower shaft assembly 13. The slide bar assembly 12 is attached to the the end of the lower shaft assembly 13, nearest the bend. The “A-Framed” axle assembly 11 is fastened to the lower shaft assembly 13.

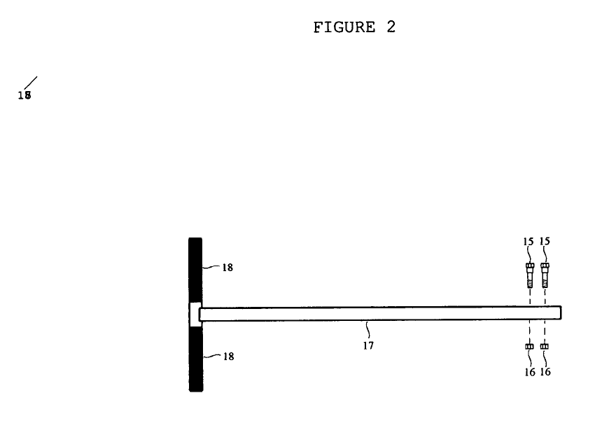

FIG. 2 shows a top view of the upper shaft 10, shown in FIG. 1, as comprising of two pieces of metal welded to form a “T”. The metal handle shaft 17 at the short member includes padded handle grip 18. The opposing end of the shaft includes drilled holes for placement of conventional fastener 15 and conventional nut 16 in assembling upper shaft 10 to lower shaft assembly 13.

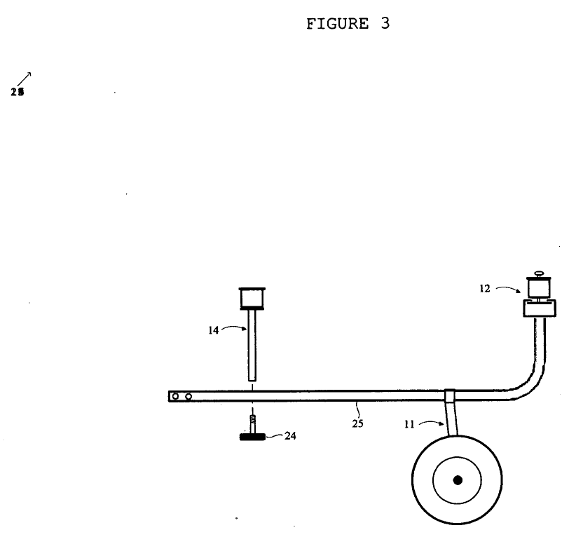

FIG. 3 is the lower shaft assembly 13, shown in FIG. 1, whose foundational component is the lower shaft 25 a ninety degree bent metal tube. The lower shaft 25 is attached to the slide bar assembly 12 at the end of the lower shaft 25 nearest the ninety degree angle. The “A-Framed” axle assembly 11 is fastened to the lower shaft 25. The vertical support assembly 14 is fastened to the lower shaft 25 by means of a handled fastener 24.

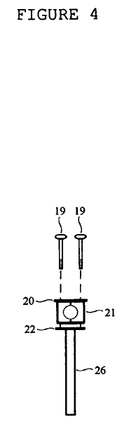

FIG. 4 is a top view of the vertical support assembly 14 shown in FIG. 1. One end of the metal tube support 26 is welded to the lower metal plate 22. The lower metal plate 22 includes two inserts which are tapped to accept conventional thumb screw 19. Using conventional thumb screw 19 the upper metal plate 20 and anti-vibration clamp 21 are fastened to the lower metal plate 22. Vertical support assembly 14 is attached to lower shaft 25, shown in FIG. 3, by a handled fastener 24 shown in FIG. 3.

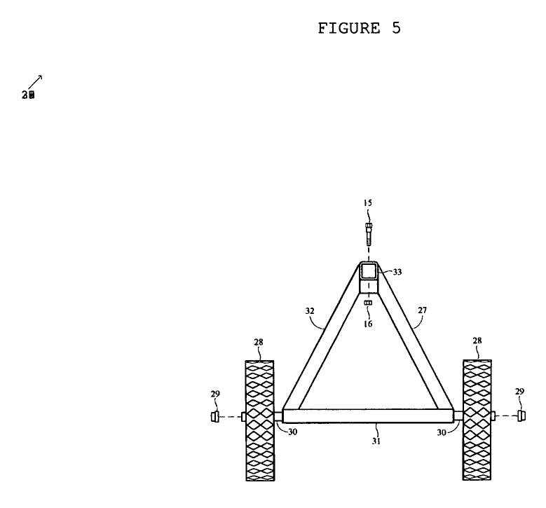

FIG. 5 is a top view of the “A-Framed” axle assembly 11 shown in FIG. 1. right leg member 27 and left leg member 32 extend downward and outward from the mounting shaft 33 to axle shaft 31. Axle 30 is inserted through the axle shaft 31 and each wheel 28 is fastened to the axle 30 at either end with an axle fastener 29.

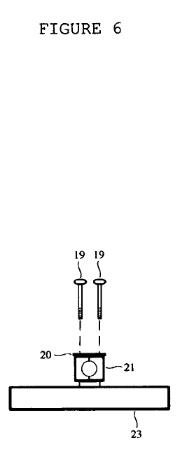

FIG. 6 is a top view of the slide bar assembly 12 shown in FIG. 1. The metal u-channel 23 encloses the lower metal plate 22 which includes two inserts tapped to accept a conventional thumb screw 19. Using conventional thumb screw 19 the upper metal plate 20 and anti-vibration clamp 21 are tightened to the lower metal plate 22. Loosening the conventional thumb screw 19 allows movement of clamp assembly from side to side.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. An universal wheeled assembly for gas and electric line trimmers for attachment for a gas or electric string trimmer to provide mobile support and eliminate the need to carry or support the weight of the trimmer. comprising:
an upper shaft, for providing weight support, comfort for operator and a means of raising trimmer from wheeled assembly frame;
an axle assembly, for allowing use on most types of terrain;
a slide bar assembly, for trimmer head direction adjusment;
a lower shaft assembly, for support of trimmer weight and means of raising trimmer from wheeled assembly frame, securely attached to said slide bar assembly, snugly fastened to said axle assembly, and removably fastened to said upper shaft;
a vertical support assembly, for vibration reduction, a secure manner to attach trimmer to universal wheeled assembly, and a pivot point, perpendicularly tightened to said lower shaft assembly;
a padded handle grip, for operator comfort;
an anti-vibration clamp, for vibration reduction; and
a mounting shaft, for mounting axle assembly to lower shaft assembly.
